(19) United States
(12) Patent Application Publication
(10) Pub. No.: US 2010/0026992 A1
(43) Pub. Date: Feb. 4, 2010

(54) SYSTEM AND METHOD FOR BUILT-IN TESTING OF A FIBER OPTIC TRANSCEIVER

(76) Inventor: Alex ROSIEWICZ, (US)

Correspondence Address: WILMERHALE/BOSTON, 60 STATE STREET, BOSTON, MA, 02109, US

(21) Appl. No.: 11/830,671

(22) Filed: Jul. 30, 2007

Related U.S. Application Data
(60) Provisional application No. 60/834,256, filed on Jul. 28, 2006.

(51) Int. Cl. G01N 21/00; G01N 21/88

(52) U.S. Cl. 356/73.1

(57) ABSTRACT

Systems and methods for testing an optical fiber involving: a laser in optical communication with an end of the fiber, the laser configured to direct a test beam of radiation into an end of the fiber; a detector in optical communication with the end of the fiber, the detector configured to detect a reflection of the test beam by a defect within the fiber; and a timer connected to the laser and to the detector, wherein the timer is capable of measuring a delay between an emission of the test beam of radiation by the laser and a detection of the emitted test beam by the detector, the delay being indicative of the position of the defect within the fiber.

### CROSS REFERENCE TO RELATED APPLICATIONS

This application claims the priority under 35 U.S.C. §119(e) of U.S. Provisional Application No. 60/834,256, filed Jul. 28, 2006.

### STATEMENT AS TO FEDERALLY SPONSORED RESEARCH

This invention was made with Government Support under Contract Number N000114-05-M-0229 awarded by the U.S. Navy. The Government has certain rights in the invention.

### TECHNICAL FIELD

This invention relates to the testing of optical fibers.

### BACKGROUND

Fiber optic communication systems can be used to transport data in systems that have components that are packed into tight configurations. For example, in an aircraft space is at a premium, and, as a result, hardware is often packed into the airframe in a manner that provides little access for maintenance. When a system failure occurs, it can be difficult to pinpoint the location of the fault because potential failure sites are inaccessible. It may then be necessary to perform cumbersome, time-consuming, and expensive dismantling of equipment in order to gain access to and inspect potential equipment that may be the source of the failure.

### SUMMARY

The described embodiments feature systems and methods of testing a fiber optic transceiver. A test system is interposed between a transmitting laser and an optical fiber. The test system directs a beam of test radiation into the fiber by reflecting the test beam off a coated glass plate. If a defect is present within the fiber, the test beam is partially or wholly reflected back long the fiber. A second glass plate disposed between the first glass plate the directs the reflected beam to a photo-detector. Measurement of a time delay between the emission of the beam of test radiation and detection of a corresponding reflection of the test beam at the detector is used to determine where the defect is located. The strength of the reflection can be used to determine the nature of the defect.

### BRIEF DESCRIPTION OF THE DRAWINGS

FIG. 1 is a schematic diagram of a built-in test system for a fiber optic transceiver.

FIG. 2 is a solid model illustration of a fiber optic transceiver containing built-in test capability.

FIGS. 3 and 4 are two views of a solid model illustration of a fiber optic transceiver containing built-in test capability.

FIG. 5 is a schematic diagram of a built-in test system retrofitted to a fiber optic transceiver.

### DESCRIPTION

The described embodiments include systems and methods of testing and detecting faults in optical fibers and fiber optic transceivers without the need to access the fiber or transceiver or perform visual inspection. The ability to provide such “built-in” testing can avoid the need to perform costly dismantling of buried components during the course of troubleshooting. Optical fibers are fragile structures, and they can partially or wholly fail when they are mechanically ruptured, or even suffer minor impact or strain, such as crimping. This problem is especially a concern when a fiber is operated in a high power mode, such as by a multimode pumped chip.

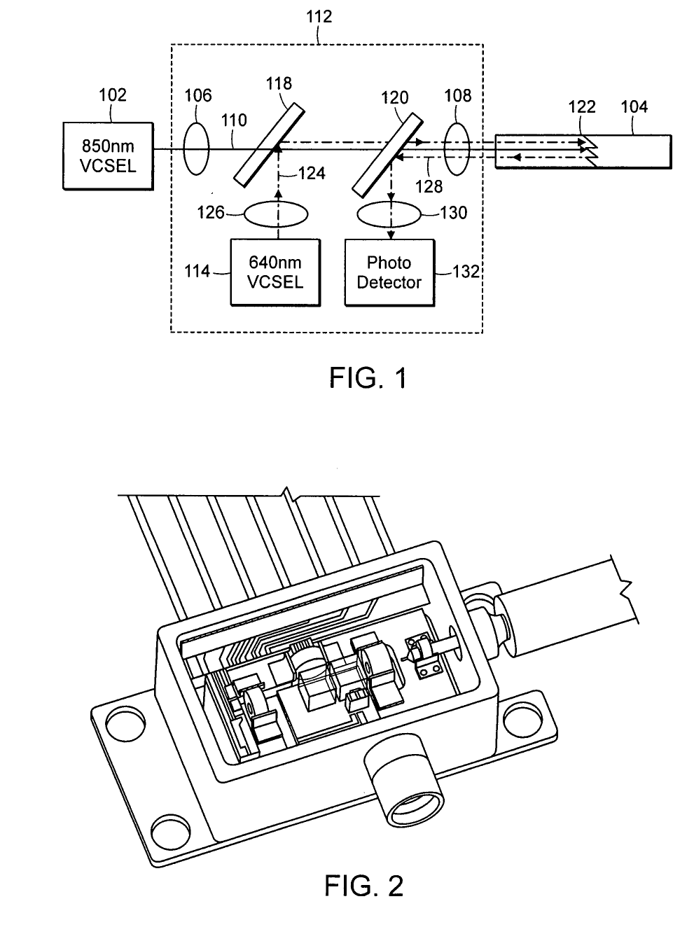

FIG. 1 is a schematic illustration of a built-in testing system for a fiber optic transceiver. An unmodified transceiver is represented by an 850 nm VCSEL (vertical cavity surface emitting laser) 102, which is in optical communication with optical fiber 104 via lenses 106 and 108, as indicated by outgoing transceiver laser beam 110. The built-in test feature described herein is shown in box 112. A second VCSEL 114 that emits at a wavelength different from the wavelength emitted by laser 102 is provided for the purpose of performing the built-in test. Laser 114 is a 640 nm wavelength laser in this example. It can be desirable for laser 114 to provide radiation in the visible range so that if a technician performs a visual inspection of the system, he or she can see the beam of laser 114. Two coated glass plates 118 and 120 are aligned at an angle, such as 45 degrees, to the direction of laser beam 110 from laser 102 to fiber 104. First plate 118 is coated on both sides with a coating that has a relatively low reflectivity at the wavelength of laser 102 (in this example, 850 nm), but a relatively high reflectivity at the wavelength corresponding to test laser 114, i.e., at about 640 nm. Second plate 120 is coated on both sides with a coating that, like first plate 118, has relatively low reflectivity at 850 nm, but unlike first plate 118, has a 50% reflectivity at 640 nm. While this embodiment uses glass plates 118 and 120, other sizes, shapes, and compositions of blocks could be used.

To determine if the fiber communication has developed a fault, such as a mechanical fault, crack, or other defect 122 in optical fiber 104, the test laser 114 is activated. Outgoing beam 124 from test laser 114 is collimated by lens 126, reflects off first glass plate 118, and travels through second glass plate 120, where, after 50% attenuation, it enters fiber 104. When outgoing test beam 124 reaches fiber defect 122, at least a part of the outgoing beam is reflected as returning test beam 128. Returning beam 128 travels back along fiber 104, partially reflects off the surface of second plate 120, and is directed through lens 130 to photodetector 132. Photodetector 132 converts return beam 128 into a corresponding electrical signal, which travels to a diagnostic system along a low bandwidth electrical data connection (not shown).

A timing delay between the emission of outgoing test beam 124 from test laser 114 and the receipt of return beam 128 at photodetector 132 indicates the location of fiber defect 122. The strength of return beam 128 gives an indication of the nature of defect 122. A strong return beam with a steep onset profile suggests a clear break or mechanical defect. By contrast, a weak return beam may indicate a partial break, or a strain on the fiber sufficient to cause a change in the fiber's refractive index near the affected portion of the fiber. In addition, multiple return signals may indicate multiple problem areas at different locations along fiber 104. If there is no defect in fiber 104 anywhere between the transceiver and the adjacent transceiver at the other end of fiber segment 104, the timing and nature of the return pulse (if any) will correspond to a return signal emanating from the transceiver at the other end of fiber segment 104, thus signaling that the fault is not to be found in fiber segment 104.

The above built-in test may thus enable a diagnostic system to pinpoint the location of a fault without the need to physically access any components. Once the suspected failure site has been identified, a maintenance technician can target repair efforts to the identified component(s).

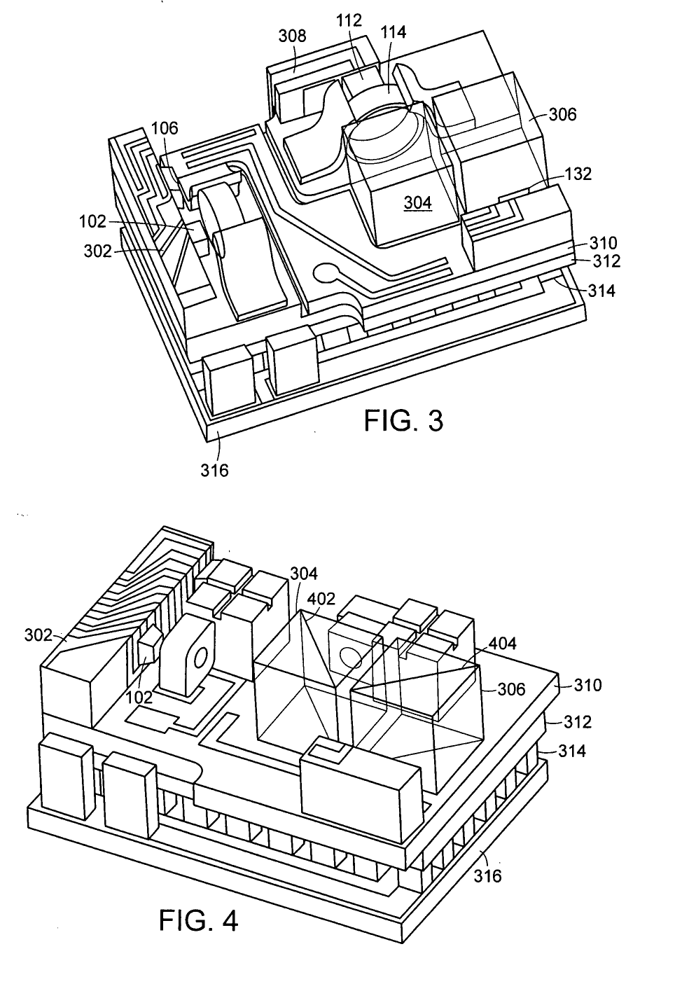

FIG. 2 is a solid model illustration of an implementation of a transceiver package that contains a built-in test capability. The subassembly depicted inside the housing is illustrated in more detail in FIGS. 3 and 4. VCSEL 102 is mounted on ceramic substrate 302; the beam from VCSEL 102 is collimated by lens 106, and passes through cubes 304 and 306, made of a transparent material such as glass, into the optical fiber (not shown). Plates 402 and 404 (FIG. 4), made of a transparent material such as glass, are functionally equivalent to first plate 118 and second plate 120 respectively (FIG. 1). Plates 402 and 404 are embedded within cubes 304 and 306. Test laser 114 is mounted on ceramic substrate 308, and is collimated by lens 114. The outgoing beam from test laser 114 (not shown) enters glass cube 304, is deflected through 90 degrees by embedded plate 402 towards glass cube 306, and enters the fiber optic (not shown) to the right of cube 306. If the outgoing beam encounters a defect in the fiber, the beam reflects off the defect, travels back along the fiber, enters cube 306, and is deflected by embedded plate 404 into a lens (not shown) and reaches photodetector 132. The entire assembly is mounted on ceramic substrate 310 which carries electrical signals between the various components, including photodetector 132. The ceramic substrate is mounted on a thermoelectric cooler comprising top plate 312, bismuth telluride columns 314, and a bottom plate 316.

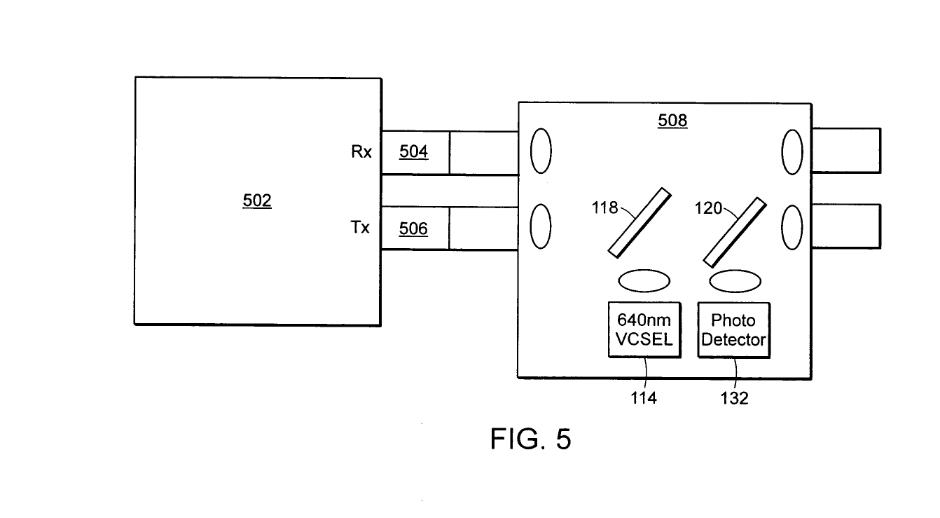

The built-in test systems described above are generally contained within a transceiver package. However, built-in test capability can also be retrofitted to an existing, non-self-testing transceiver without the need to disturb the transceiver package. FIG. 5 illustrates a retrofitted built-in test system. Transceiver 502 is connected to incoming fiber 504 and outgoing fiber 506. Retrofitted built-in test module 508 is inserted across incoming fiber 504 and outgoing fiber 506 without affecting transceiver 502. Built-in test module 508 contains the same components as described above, including test laser 114, first glass plate 118, second glass plate 120, and photodetector 132.

Having described certain embodiments, it should be apparent that modifications can be made without departing from the scope. The specific lasers and wavelengths are examples and other devices with other characteristics can be used. While one expected benefit is the ability to test optical fiber devices with limited access for testing and maintenance, the system does not have to be used with such a device.

Other embodiments are within the following claims.

1. A system for testing an optical fiber for transmitting a beam of radiation from a primary laser having a first wavelength, the system comprising:
a test laser for emitting a test beam of radiation at a second wavelength;
a first block substantially transmissive at the first wavelength and substantially reflective at the second wavelength, the test beam being incident on the first block, the first block being configured to reflect the test beam into the fiber;
a second block substantially transmissive at the first wavelength and partially reflective at the second wavelength, the second block disposed between the first block and the fiber, a reflection of the test beam from a defect within the fiber being incident on the second block;
a photo-detector for detecting the reflection of the test beam from the defect, the second block being configured to reflect the reflected test beam of radiation into the photo-detector; and
a timer connected to the test laser and to the photo-detector, wherein the timer is capable of measuring a delay between an emission of the test beam of radiation by the test laser and a detection by the photo-detector of a corresponding reflection of the emission of the test beam, the delay being indicative of a position of the defect within the fiber.

2. The system of claim 1, wherein the fiber defines an axis and the test beam is emitted from the test laser in a direction perpendicular to the axis.

3. The system of claim 1, wherein the test laser is a 640 nm vertical cavity surface emitting laser.

4. The system of claim 1, wherein the primary laser is a vertical cavity surface emitting laser and the first wavelength is 850 nm.

5. The system of claim 1, wherein the first block comprises a first coated glass plate and the second block comprises a second coated glass plate.

6. The system of claim 1, wherein the photo-detector is further capable of detecting a strength of the reflection of the test beam from the fiber.

7. The system of claim 6, wherein the strength of the reflection is used to determine a characteristic of the defect.

8. A method of testing an optical fiber for transmitting a beam of radiation from a primary laser having a first wavelength, the method comprising:
emitting a test beam of radiation at a second wavelength;
providing a first block substantially transmissive at the first wavelength and substantially reflective at the second wavelength;
directing an emission of the test beam onto the first block;
configuring the first block to reflect the incident test beam into the fiber;
providing a second block substantially transmissive at the first wavelength and partially reflective at the second wavelength, the second block disposed between the first block and the fiber, a reflection of the test beam from a defect within the fiber being incident on the second block;
providing a photo-detector for detecting the reflection of the test beam from the defect;
configuring the second block to reflect the reflection of the test beam from the defect into photo-detector; and
measuring a time delay between the emission of the test beam of radiation and a corresponding detection of the emission of the test beam by the photo-detector, the delay being indicative of a position of the defect within the fiber.

9. The method of claim 8, wherein the fiber defines an axis and the test beam is emitted from the test laser in a direction perpendicular to the axis.

10. The method of claim 8, wherein the test beam has a wavelength of 640 nm and is emitted by a vertical cavity surface emitting laser.

11. The method of claim 8, wherein the primary laser is a vertical cavity surface emitting laser and the first wavelength is 850 nm.

12. The method of claim 8, wherein the first block comprises a first coated glass plate and the second block comprises a second coated glass plate.

13. The method of claim 8, wherein the photo-detector detects a strength of the reflection of the test beam from the fiber.

14. The method of claim 13, further comprising using the detected strength of the reflection to determine a characteristic of the defect.

15. A system for testing an optical fiber comprising:
a laser in optical communication with the fiber, the laser configured to direct an emission of a test beam of radiation into the fiber;
a detector in optical communication with the fiber, the detector configured to detect a reflection of the emission of the test beam by a defect within the fiber; and
a timer connected to the laser and to the detector, wherein the timer is capable of measuring a delay between the emission of the test beam of radiation by the laser and a detection of a reflection of the emission of the test beam by the detector, the delay being indicative of a position of the defect within the fiber.

16. The system of claim 15 further comprising a first coated glass plate substantially reflective of the test beam, the test beam being directed into the fiber by reflection from the first coated glass plate.

17. The system of claim 16 further comprising a second coated glass plate partially reflective of the test beam, wherein the reflection of the test beam from the defect within the fiber is directed to the detector by reflection from the second coated glass plate.

18. A method of testing an optical fiber, the method comprising:
directing an emission of a test beam of coherent radiation into the fiber;
detecting a reflection of the emission of the test beam by a defect within the fiber; and
measuring a delay between the emission of the test beam and a detection of a reflection of the emission of the test beam, the delay being indicative of a position of the defect within the optical fiber.

19. The method of claim 18 further comprising providing a first coated glass plate that is substantially reflective of the test beam and configuring the first coated glass plate to reflect the test beam into the fiber.

20. The method of claim 19 further comprising providing a second coated glass plate that is partially reflective of the test beam and configuring the second coated glass plate to reflect the reflection of the test beam from the defect into the detector.
